(19) United States
(12) Patent Application Publication
(10) Pub. No.: US 2015/0003607 A1
(43) Pub. Date: Jan. 1, 2015

(54) SECURE CONNECTION METHOD AND APPARATUS OF ELECTRONIC DEVICE

(71) Applicant: Samsung Electronics Co., Ltd., Gyeonggi-do (KR)

(72) Inventors: Jongmu Choi, Gyeonggi-do (KR); Sunghee Lee, Gyeonggi-do (KR); Changsoon Kim, Gyeonggi-do (KR)

(21) Appl. No.: 14/316,681

(22) Filed: Jun. 26, 2014

Related U.S. Application Data
(60) Provisional application No. 61/839,632, filed on Jun. 26, 2013.

(30) Foreign Application Priority Data
Jun. 26, 2014 (KR) 10-2014-0079173

(51) Int. Cl. H04L 9/08

(52) U.S. Cl. CPC H04L 9/0863; H04L 2209/24
USPC 380/44

(57) ABSTRACT

A secure connection method and apparatus is provided for establishing secure connections among a plurality of electronic devices forming a group network. The data communication method includes generating, when creating or joining a group network, an encryption key using a password entered by a user. The data communication method also includes generating an identifier of the group network. The data communication method further includes generating a hash function predefined among the electronic devices of the group network. The data communication method includes performing data communication using the encryption key.

### CROSS-REFERENCE TO RELATED APPLICATION(S) AND CLAIM OF PRIORITY

The present application is related to and claims the benefit under 35 U.S.C. §119(e) of U.S. Provisional application No. 61/839,632 filed on Jun. 26, 2013 in the U.S. Patent and Trademark Office, and claims the benefit under 35 U.S.C. §119(a) of a Korean patent application No. 10-2014-0079173 filed in the Korean Intellectual Property Office on Jun. 26, 2014, the entire disclosures of which are hereby incorporated by reference.

### TECHNICAL FIELD

The present disclosure relates to a method and apparatus for establishing secure connections among a plurality of electronic devices forming a group network.

### BACKGROUND

Typically, Wireless Local Area Network (WLAN) or wireless fidelity (Wi-Fi) can operate in one of two operation modes: infrastructure mode and Independent Basic Service Set (IBSS) mode. Depending on the nature of electronic device, the laptop computer can mainly operate in the infrastructure mode to use Internet in connection to an Access point (AP), and the embedded platform device (such as smartphone, PDA, PSP, portable game console, and digital camera) in both the Infrastructure mode/IBSS mode. In the MSS mode, it can be possible to form a group communication network made up of electronic devices using Wi-Fi technology without an AP. However, a secure connection establishment among a large number of electronic devices can cause time delay and create a burden of storing large number of encryption keys in each electronic device. Thus, there is a need for improved systems and methods.

### SUMMARY

In a first example, a secure connection method and apparatus of the present disclosure is capable of facilitating secure group connection by minimizing the connection delay with least user interaction.

In a second example, the secure connection method and apparatus of the present disclosure is capable implementing the optimal environment for supporting secure group connection among a plurality of electronic devices, resulting in improvement of user convenience and device usability.

To address the above-discussed deficiencies, it is a primary object to provide a data communication method of an electronic device. The data communication method includes generating an identifier of a group network based on a password entered by a user. The method also includes generating an encryption key based on the password and the identifier. The method further includes communicating data using the encryption key in the group network.

In a third example, a data communication method of an electronic device is provided. The data communication method includes receiving a beacon frame broadcast by another electronic device in a group network. The method also includes extracting an identifier of the group network from the beacon frame. The method further includes generating an encryption key based on the identifier and a password entered by a user. The method includes performing data communication using the encryption key within the group network.

In a fourth example, a computer readable storage medium storing a program of instructions executable by a machine to perform a data communication method is provided. The data communication method includes generating an identifier of a group network based on a password entered by a user. The data communication method also includes generating an encryption key based on the password and the identifier. The data communication method further includes communicating data using the encryption key in the group network.

In a fifth example, a computer readable storage medium storing a program of instructions executable by a machine to perform a data communication method is provided. The data communication method includes receiving a password entered by a user. The data communication method also includes acquiring an identifier of a group network. The data communication method further includes executing a hash function with input of the password and the identifier. The data communication method includes generating an encryption key for communicating encrypted data in the group network.

In a fifth example, an electronic device is provided. The electronic device includes a storage unit configured to store a hash function for use in an encryption key and at least one program. The electronic device also includes a control unit including at least one processor for executing the at least one program configured to control data communication of the electronic device in a group network. The at least one program includes a program configured to generate the encryption key for use in data communication in the group network using a password entered by a user, an identifier of the group network, and the hash function.

In a sixth example, a data communication system is provided. The data communication system includes a first electronic device configured to generate an identifier of a group network based on a password entered by a user. The first electronic device is also configured to generate an encryption key using the password, the identifier, and a predefined hash function. The first electronic device is further configured to communicate data encrypted with the encryption key with other electronic devices in the group network and a second electronic device configured to acquire the identifier from a frame broadcast by the first electronic device. The second electronic device is also configured to generate an encryption key identical with the encryption key of the first electronic device using a password entered by a user, the identifier, and the hash function. The second electronic device is also configured to communicate data encrypted with the encryption key with the first electronic device.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is an example block diagram illustrating a configuration of the electronic device according to this disclosure;

FIG. 2 is an example diagram illustrating a network environment including the electronic devices establishing secure connections according to this disclosure;

FIG. 3 is an example signal flow diagram illustrating signal flows between electronic devices for group communication according to this disclosure;

FIG. 4 is an example diagram illustrating a principle of the encryption key generation procedure of the electronic device according to this disclosure;

FIG. 5 is an example flowchart illustrating an encryption key generation procedure of an electronic device for forming a group network according to this disclosure; and

FIG. 6 is an example flowchart illustrating an encryption key generation procedure of an electronic device for group communication according to this disclosure.

### DETAILED DESCRIPTION

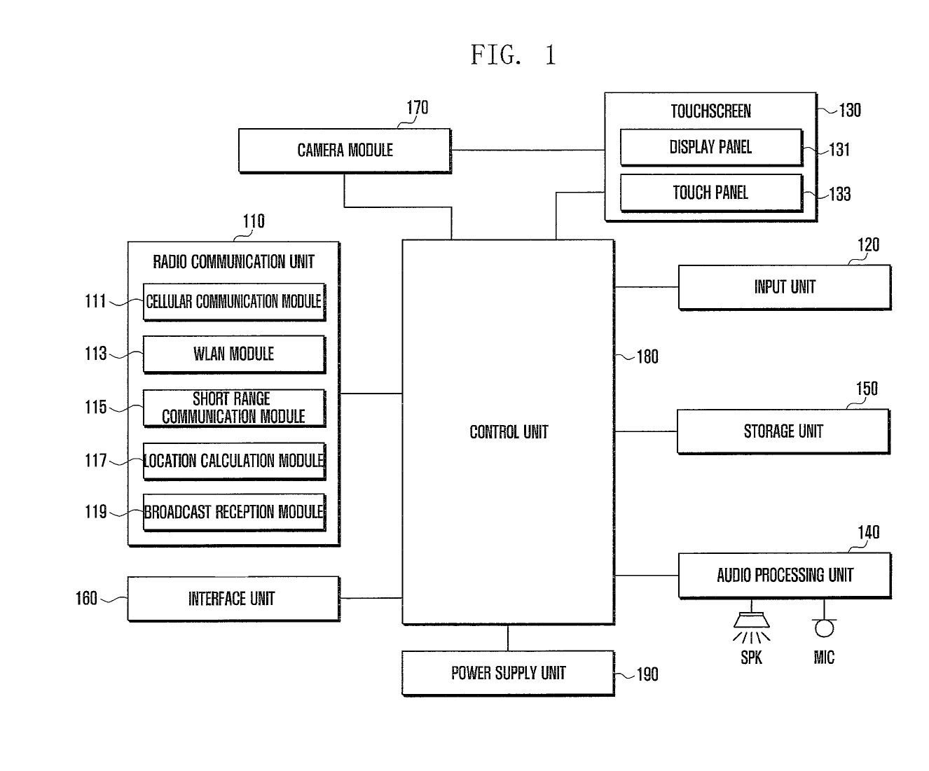

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device. Exemplary embodiments of the present disclosure are described with reference to the accompanying drawings in detail. The same reference numbers are used throughout the drawings to refer to the same or like parts. Detailed description of well-known functions and structures incorporated herein may be omitted to avoid obscuring the subject matter of the present disclosure. This aims to omit unnecessary description so as to make the subject matter of the present disclosure clear.

Typically, Wireless Local Area Network (WLAN) or wireless fidelity (Wi-Fi) can operate in one of two operation modes: infrastructure mode and Independent Basic Service Set (IBSS) mode. Depending on the nature of electronic device, the laptop computer can mainly operate in the infrastructure mode to use Internet in connection to an Access point (AP), and the embedded platform device (such as smartphone, PDA, PSP, portable game console, and digital camera) in both the Infrastructure mode/IBSS mode. In the IBSS mode, it can be possible to form a group communication network made up of electronic devices using Wi-Fi technology without an AP.

Since there is no need of AP for centralized management in the IBSS mode-based group communication among the electronic devices, the individual electronic devices can set up 1:1 secure connections. Typically, Wi-Fi Protected Access Pre-Shared Key (WPA-PSK) and Wi-Fi Protected Setup (WPS) can be representative secure connection techniques.

In the case of WPA-PSK based secure connection, the electronic devices can perform 4-way handshake in 1:1 in the state of sharing the same password to exchange encryption key (such as Pairwise Transient Key (PTK)). In the WPA-PSK based secure connection, however, if there are too many electronic devices requiring securing connections, the secure connection setup procedure can be performed repeatedly in proportion to the number of electronic devices, resulting in inconvenience.

In the case of WPS-based secure connection, the electronic devices can perform performs WPS procedure in 1:1 to exchange the encryption key. In WPS mode, the paired electronic devices establish a connection using NFC or PBC instead of sharing password and can perform 4-way handshake internally. Since the WPS-based secure connection does not support session overlapping, the electronic devices can perform the connection setup procedure in 1:1 repeatedly in series.

In order to establish secure connections among the electronic devices in IBSS mode, IBSS with Wi-Fi Protected Setup standard can be ratified by Wi-Fi Alliance (WFA). However, since the WPA procedure has to be performed in 1:1 among electronic devices, the number of 4-way handshake processes can increase in proportion to square of the number of individual electronic devices participated in the group communication. For example, if there are n electronic devices intending to participate in the group communication, total number of 4-way handshake processes to be performed can be n*(N−1). This can mean that the secure connection establishment among the large number of electronic devices causes time delay and burden of storing large number of encryption keys in each electronic device.

A method of supporting secure group connection among a plurality of electronic devices forming a group network is provided. The secure connection establishment for the group network can be classified into two cases: first, participating in the initial creation of the group network and second, joining the group network created already.

In the case of participating in the initial creation of the group network, the electronic device can receive a password entered by the user and generate a temporary value (such as a number used once), such as a 48-bit temporary value, in correspondence to the password. The electronic device can generate a short length value or key based on the password and temporary value. For example, the electronic device can execute a predetermined hash function with the input of the password and temporary value and generate a security-reinforced encryption key (such as a 128-bit encryption key) finally. In an embodiment, the encryption key can be used in encrypting and decrypting a Media Access Control (MAC) frame. The temporary value (such as a 48-bit temporary value) can be configured as a group network identifier (such as a 48-bit Basic Service Set Identifier (BSSID)) included in the frame transmitted periodically (such as a beacon frame).

The electronic device participating in the initial creation of a group network can receive the frame (such as a beacon frame) transmitted by another electronic device participating in the group network. The electronic device can extract the group network ID (such as a 48-bit BSSID) from the received frame and wait for user input of password. The electronic device can extract the identifier when a password is input by the user. If the password is input by the user, the electronic device can execute a predefined hash function to generate the security-reinforced encryption key (such as a 128-bit encryption key) necessary for secure connection in the group network. The electronic device can encrypt and decrypt the MAC frame using this encryption key.

The electronic device can participate in creating a group network or join the group network created by other electronic devices. When the electronic device participates in creating a group network or join the group network, it can generate an encryption key (such as a 128-bit encryption key) using a hash function shared among the electronic devices and perform data communication secured based on the encryption key.

In an embodiment, the electronic device can be any of devices having at least one of Application Processor (AP), Graphic Processing Unit (GPU), and Central Processing Unit (CPU), such as information communication devices, multimedia devices, wearable devices, and their equivalents.

The electronic device can be a device equipped with a communication function. Examples of the electronic device can include smartphone, table Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical appliance, camera, wearable device (such as head-mounted device (HMD) such as electronic glasses, electronic clothing, electronic bracelet, electronic necklace, electronic appcessory, electronic tattoo, smartwatch, and their equivalent devices.

The electronic device can be a smart home appliance equipped with a communication function. Examples of the smart electronic appliance as an electronic device can include television, Digital Video Disk (DVD) player, audio player, refrigerator, air-conditioner, vacuum cleaner, electronic oven, microwave oven, laundry machine, air cleaner, set-to box, TV box (such as Samsung HomeSync™, Apple TV™, and Google TV™), game console, electronic dictionary, electronic key, camcorder, and electronic frame, etc.

Examples of the electronic device can include medical devices (such as Magnetic Resonance Angiography (MRA), Magnetic Resonance Imaging (MRI), Computed Tomography (CT)), Navigation device, Global Positioning System (GPS) receiver, Event Data Recorder (EDR), Flight Data Recorder (FDR), car infotainment device, maritime electronic device (such as maritime navigation device and gyro compass), aviation electronic device (avionics), security device, vehicle head unit industrial or home robot, Automatic Teller's Machine (ATM) of financial institution, Point Of Sales (POS), and the like.

Examples of the electronic device can include furniture and building/structure having a communication function, electronic board, electronic signature receiving device, projector, and metering device (such as water, electric, gas, and electric wave metering devices).

In an embodiment, the electronic device can be a flexible device.

In an embodiment, the electronic device can be any or a combination of the aforementioned devices, without limitation thereto obviously.

FIG. 1 is an example block diagram illustrating a configuration of the electronic device according to this disclosure.

As shown in FIG. 1, the electronic device 100 can include a radio communication unit 110, an input unit 120, a touchscreen 130, an audio processing unit 140, a storage unit 150, an interface unit 160, a camera module 170, a control unit 180, and a power supply unit 190. In an embodiment, the electronic device 100 may not be limited to the configuration of FIG. 1 and can be implemented with or without any of the aforementioned components.

The radio communication unit 110 can include at least one communication module responsible for radio communication with a radio communication system or another electronic device. For example, the radio communication unit 110 can include a cellular communication module 111, a Wireless Local Area Network (WLAN) module 113, a short range communication module 115, a location calculation module 117, and a broadcast reception module 119.

The cellular communication module 111 can communicate radio signals with at last one of a cellular network base station, an external electronic device, and a server (such as an integration server, provider server, content server, Internet server, and cloud server). The radio signal can carry various formats of data concerning voice communication, video communication, and text/multimedia messaging services.

The cellular communication module 111 can receive various data (such as a log, content, message, email, image, video, weather information, location information, and time information). The cellular communication module 111 can establish a connection with one of other electronic device and server to acquire (such as receive) various data. The cellular communication module 111 can transmits various data necessary for operation of the electronic device 100 to an external device (such as a server and one or more other electronic devices) in response to a user request.

The WLAN module 113 can be a module for establishing a radio link with a wireless Internet access point or another electronic device. The WLAN module 113 can be an embedded or detachable module. Examples of wireless Internet access technologies include Wi-Fi, Wireless Broadband (WiBro), World Interoperability for Microwave Access (WiMAX), and High Speed Downlink Packet Access (HSDPA).

The WLAN module 113 can transmit and receive data selected by the user to and from an external node. In an embodiment, the WLAN module 113 can acquire data from at least one of electronic devices and servers connected through a network (such as a wireless IP network). The WLAN module 113 can transmit or receive data to or from an external node (such as a server) in response to the user request. The WLAN module 113 can transmit or receive various data selected by the user to or from another electronic device in setting up a WLAN link with the electronic device. The WLAN module 113 can stay in the turn-on state or be turned on as scheduled or in response to a user input.

The short range communication module 115 is the module for short range communication. Short range communication technologies can include Bluetooth, Bluetooth Low Energy (BLE), Radio Frequency Identification (RFID), Infrared Data Association (IrDA), Ultra Wideband (UWB), ZigBee, Near Field Communication (NFC), and the like.

The short range communication module 115 can receive data. In an embodiment, the short range communication module 115 can receive data from another electronic device connected to the electronic device 100 through a network (such as short range communication network). The short range communication module 115 can transmit and receive data selected by the user to and from another electronic device in setting up a short range communication link. The short range communication module 115 can stay in the turn-on state or be turned on as scheduled or in response to a user input.

The location calculation module 115 can be the module for acquiring the location of the electronic device 100 and represented by Global Positioning System (GPS) module. The location calculation module 115 can calculate distances from three or more base stations and time information and perform triangulation with the calculated information to acquire the current location defined with latitude, longitude, and altitude. The location calculation module 115 receives the location information on the electronic device 100 from three or more satellites in real time to calculate current location of the electronic device 100. The location of the electronic device can be acquired using various methods.

The broadcast reception module 119 can receive the broadcast signal (such as a TV broadcast signal, radio broadcast signal, and data broadcast signal) and/or broadcast-related information (such as an information on the broadcast channel, broadcast program, and broadcast service provider) through a broadcast channel.

The input unit 120 can generate input data corresponding to the user input for controlling operation of the electronic device 100. The input unit 120 can include at least one of a keypad, a dome switch, a touchpad (such as a resistive/capacitive touchpad), a jog wheel, a jog switch, a sensor, etc. In an embodiment, the sensor can include voice recognition sensor, infrared sensor, acceleration sensor, gyro sensor, terrestrial magnetism sensor, illuminance sensor, color sensor, image sensor, temperature sensor, proximity sensor, motion recognition sensor, pressure sensor, and the like.

The input unit 120 can be implemented in the form of buttons one side of the electronic device or a touch panel covering a part or a whole surface of one side of the electronic device 100. In an embodiment, the input unit 120 can receive a user input for initiating the operation of the electronic device and generate a signal corresponding to the user input. For example, the input unit 120 can generate various input signals corresponding to the user inputs for application execution, data input, device posture change, content display, secure group network connection, and data transmission and reception.

The touchscreen 130 can be an input/output means responsible for receiving user input and displaying information and can include a display panel 131 and a touch panel 133. In an embodiment, the touchscreen can display various screens concerning the operations of the electronic device by means of the display panel 131. Examples of the various screens can include messenger screen, call progression screen, game screen, motion picture playback screen, gallery screen, webpage screen, home screen, and group network connection screen. The touchscreen 130 can detect a user's gesture such as touch gesture, hovering gesture, and air gesture by means of the touch panel 133 and generate an input signal corresponding to the detected gesture to the control unit 180 in the state of displaying a specific screen. The control unit 180 can identify the detected gesture and execute an operation in correspondence to the identified gesture.

The display panel 131 can display (such as output) various types of information processed in the electronic device. For example, if the electronic device 100 is in the communication mode, the display panel 131 can display a User Interface (UI) or Graphic User Interface (GUI) concerning the communication mode. If the electronic device is in the video communication mode or camera mode, the display panel 131 can display the UI or GUI concerning the corresponding mode along with the captured and/or received image. The display panel 131 can display data and contents concerning the operations of the electronic device 100 and the group network of the electronic devices. The display panel 131 can display various application execution screens of the corresponding applications.

The display panel 131 can display the screen in a landscape mode or a portrait mode and switch the screen between the landscape and portrait modes according to the rotation direction (such as the orientation) of the electronic device 100. The display panel 131 can be implemented as any of Liquid Crystal Display (LCD), Thin Film Transistor LCD (TFT LCD), Light Emitting Diode (LED), Organic LED (OLED), Active Matrix OLED (AMOLED), flexible display, bended display, 3-Dimensional (3D) display, and the like. The display panel 131 can be implemented as a transparent display panel through which the light penetrates.

The touch panel 133 can be placed on the display panel 131 to detect the user's gesture made on the surface of the touch screen 130. Examples of the user's gesture can include single touch gesture, multi-touch gesture, hovering gesture, and air gesture. Examples of the touch gesture can include tap, drag, sweep, flick, drag & drop, drawing (such as a scribing). The touch panel 133 can detect the user's gesture (such as touch gesture and proximity) made on or above the surface of the touchscreen 130 and generate a corresponding signal to the control unit 180. The control unit 180 can execute an operation corresponding to the user input concerning the position where the gesture is detected based on the signal from the touch panel 133.

In an embodiment, the touch panel 133 can detect the user input for initiating the operation concerning the use of the electronic device and generate an input signal corresponding to the user input.

The touch panel 133 can be configured to convert the change in pressure or capacitance at a certain position of the display panel 131 to an electric signal. The touch panel 133 can detect a touch gesture or approaching position and size of an input means (such as a user's finger and an electric pen) on the surface of the display panel 131. The touch panel 133 can be configured to detect the pressure of a touch gesture depending on the type of panel. If a touch or approaching gesture to the touch panel 133 is detected, the touch panel 133 can generate one or more corresponding signals to a touch controller (. The touch controller can process the one or more signals and transmit the processed one or more signals to the control unit 180. The control unit 180 can check the position where the touch or approaching gesture is detected on the touchscreen 130 and can execute a corresponding function.

The audio processing unit 140 can be responsible for transferring the audio signal from the control unit 180 to the speaker (SPK) 141 and transferring the audio signal corresponding to the voice input through the microphone (MIC) 143 to the control unit 180. The audio processing unit 140 can process the voice/sound data to output through the speaker 141 in the form of audible sound wave and convert the sound such as voice input through the microphone 143 to digital audio signal and transfer the audio signal to the control unit 180. The audio processing unit 140 can output the audio information (such as a sound effect and a music file) included in the data in response to the user input.

The speaker 141 can output the audio data received by the radio communication unit 110 and stored in the storage unit 150. The speaker 141 also can output the sound effects concerning various operations (such as functions) of the electronic device 100.

The microphone 143 can convert the input sound wave to an electric signal. In the telephone mode, the sound wave input through the microphone can be converted to a format suitable for being transmitted by means of the cellular communication module 111. One of various noise reduction algorithm can be adopted to the microphone 143 to cancel the noise occurring in the course of receiving external sound wave.

The storage unit 150 can store application programs capable of being executed by the control unit 180 semi-persistently and the input/output data temporarily. The input/output data can include logs, contents, messenger data (such as chat data), contact information (such as phone numbers), messages, media files (such as audio and still and motion picture files).

The application programs can include the program generating an encryption key for secure data communication in the group network based on the password entered by the user, group network identifier, and the hash function predefined commonly among the electronic devices constituting the group network. In an embodiment, the electronic devices of the group network can store the same hash function and generate the same encryption key based on the hash function.

The storage unit 1520 can store various programs and data related to the group network connection of the electronic device 100. In an embodiment, the storage unit 1520 can store the hash function for generating the security-reinforced encryption key.

The storage unit 150 can store the usage frequency (such as an application usage frequency and content usage frequency), significance level, and priority. The storage unit 150 also can store the various patterns of vibrations and sound effects output in response to the touch-based and proximity-based inputs made on the touchscreen 130. The storage unit 150 can store the Operating System (OS) of the electronic device 100 and programs concerning the touchscreen-based input and display control and other operations of the electronic device, and data generated by the programs semi-persistently or temporarily.

The storage unit 150 can be implemented with a storage medium of at least one of a flash memory type, hard disk type, micro type, card type (such as Secure Digital (SD) type and eXtream Digital (XD) card type) memories; and Random Access Memory (RAM), Dynamic RAM (DRAM), Static RAM (SRAM), Read-Only Memory (ROM), Programmable ROM (PROM), Electrically Erasable PROM (EEPROM), Magnetic RAM (MRAM), magnetic disk, optical disk type memories. The electronic device 100 can interoperate with a web storage working as the storage unit 150 on the Internet.

The interface unit 160 can provide the interface for the external devices connectable to the electronic device 100. The interface unit 160 can transfer the data or power from the external devices to the internal components of the electronic device 100 and transfer the internal data to the external devices. For example, the interface unit 160 can be provided with wired/wireless headset port, external charging port, wired/wireless data port, memory card slot, identity module slot, audio input/output port, video input/output port, earphone jack, and the like.

The camera module 170 can be responsible for photo shooting function of the electronic device 100. The camera module 170 can shooting a still or motion image of a scene. The camera module 170 can shoot a picture of a scene and output the video data of the picture to the display panel 131 and the control unit 180 under the control of the control unit 180. The camera module 170 can including an image sensor (such as a camera sensor) for converting optical signal to electric signal and a video signal processor for converting the electronic signal received from the image sensor to digital video data. The image sensor can be a Charge-Coupled Device (CCD) or a Complementary Metal-Oxide-Semiconductor (CMOS) sensor. The camera module 170 can provide image processing function for supporting photo shooting according to various shooting options set by the user (such as zooming), screen aspect ratio, visual effect (such as sketch, mono, sepia, vintage, mosaic effect).

The control unit 180 can control overall operations of the electronic device 100. For example, the control unit 180 can control the operations of voice telephony, data communication, and video conference. In an embodiment, the control unit can control the operations concerning the secure connection establishment among the electronic devices. For example, the control unit 180 can control the operations of creating a group network, joining the group network, and generating encryption key concerning the secure connection to the group network.

The control unit 180 can receive a password entered by the user and generate a temporary value (such as a 48-bit temporary value) based on the password. The control unit 180 can execute a predefined hash function stored in the storage unit 150 to generate an encryption key (such as a 128-bit encryption key) with the input of the password and temporary value. After creating the group network, the control unit 180 can broadcast a frame (such as a beacon frame) including a group network identifier (such as a 48-bit BSSID) periodically in order for other electronic device to identify the group network.

The control unit 180 can receive the frames (such as beacon frames) broadcast by other electronic devices periodically in the group network and extract the group network identifiers (such as a 48-bit BSSID) from the frames in order for the electronic device 100 to join the group network. If a password is input by the user, the control unit 180 can execute the hash function stored in the storage unit 150 to generate an encryption key (such as a 128-bit encryption key) based on the extracted network identifier and the password entered by the user.

In an embodiment, the encryption key generated by the electronic device 100 can be used to encrypt and decrypt MAC frames. For example, the control unit 180 can control transmitting/receiving the data encrypted with the encryption key in the group network to which the electronic device belongs. In an embodiment, the control unit 100 can transmit data encrypted with the encryption key and decrypt the data transmitted by other electronic device of the group network using the encryption key.

The control unit 180 can include one or more processors capable of executing at least one program stored in the storage unit 150 and control data communication of the electronic device 100 in the group network. For example, the control unit 180 can include a module for processing the password entered by the user, a module for generating or extracting an identifier (such as a 48-bit BSSID), and a module for executing a hash function to generate security-reinforced encryption key (such as a 128-bit encryption key).

The control unit 180 can control the operations of basic functions of the electronic device 100. For example, the control unit 180 can control executing a certain application and displaying the application execution screen. The control unit 180 also can receive the touch-based and proximity-based input signal by the input interface (such as touchscreen 130) and execute the function corresponding to the input signal. The control unit 180 can control transmitting/receiving data through wired and/or wireless communication channel.

The power supply unit 190 can supply the power from an external or internal power source to the components of the electronic device 100 under the control unit control unit 180. In an embodiment, the power supply unit 190 can turn on/off the power to the display panel under the control of the control unit 180.

The secure connection methods can be implemented in software, hardware, or combination of both and stored in a computer-readable storage medium. In the case of the hardware implementation, the gesture-based data processing method can be implemented with at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and other electrical units which perform certain tasks.

Here, the storage medium can be any of the computer-readable storage media storing the program commands of receiving password entered by the user, acquiring group network identifier, executing a hash function with the input of the password and the group network identifier, and generating encryption key for use in transmitting/receiving encrypted data in the group network.

In an embodiment, the electronic device participating in the creation of a group network can generate a 48-bit temporary value based on the password entered by the user and configure the temporary value as a group network identifier. In an embodiment, the electronic device joining the group network created already can receive beacon frames broadcast periodically by other electronic devices of the group network and extract the group identifier from the beacon frames.

In an embodiment, the hash function can be shared in advance among the electronic devices of the network group such that the electronic devices of the group network generate 128-bit encryption key using the hash function identically. That is, the electronic devices belonging to the group network can encrypt and decrypt data using the same encryption key for the data communication within the group network.

In an embodiment, the secure contention method can be implemented by the control unit 180 in itself. In the case of being implemented in software, the above-described processes and functions can be implemented in the form of software modules. The software modules can perform the corresponding functions and operations as described above.

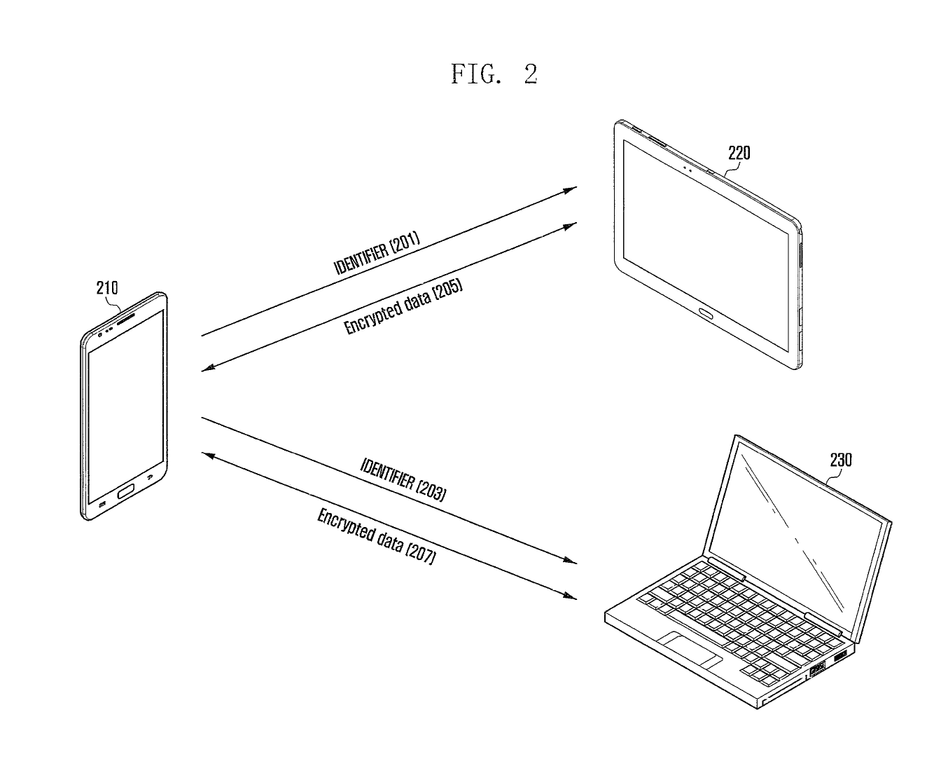

FIG. 2 is an example diagram illustrating a network environment including the electronic devices establishing secure connections according to this disclosure.

As shown in FIG. 2, the first electronic device 210 can initiate the operation of creating a group network, and the second and third electronic devices 220 and 230 can participate in the group network created by the first electronic device 210. The first, second, and third electronic devices 210, 220, and 230 respectively, can store the same hash function. In an embodiment, The first, second, and third electronic devices 210, 220, and 230 respectively, can operate in the Independent Basic Service Set (IBSS) mode in which the electronic devices communicate among each other directly without involvement of any Access Point (AP).

In an embodiment, the electronic devices 210, 220, and 230 can include both the AP station and non-AP station broadly as functional entities including Medium Access Control (MAC) and Physical Layer interface of wireless media in compliance with the Institute of Electrical and Electronics Engineers (IEEE) 802.11 standard.

Referring to FIG. 2, the first electronic device 210 can receive a password entered by the user and generates a group network identifier (such as a 48-bit temporary value) based on the password and then an encryption key (such as a 128-bit encryption key) using a predetermined hash function based on the password and the group network identifier. The first electronic device 210 can broadcast a frame (such as a beacon frame) including the group network identifier for the adjacent electronic devices (such as a second and third electronic devices 220 and 230).

The second and third electronic devices 220 and 230 can receive the frame broadcast by the first electronic device 120 and extract the group network identifier from the frame. The second and third electronic devices 220 and 230 can generate the encryption key (such as a 128-bit encryption key) for use in radio communication using a predetermined hash function with the password entered by the user and the extracted group network identifier. The second and third electronic devices 220 and 230 can store the same hash function as the first electronic device 210 to generate the encryption key identical with that generated by the first electronic device 210.

Referring to FIG. 2, the secure connection procedure can be performed in such a way that the first electronic device 210 detects the user manipulation for creating a group network and password entered by the user and generates a temporary value based on the password. The first electronic device 210 can configure the group network identifier (such as a BSSID) based on the temporary value and broadcast the beacon frame including the group network identifier periodically. That is, the first electronic device 210 can transmit the beacon frame including the group network identifier to the other electronic devices (such as the second and third electronic devices 220 and 230 as denoted by reference numbers 201 and 203). The first electronic device 210 can generate the encryption key by executing the predefined hash function with the input of the password and the temporary value.

The second and third electronic devices 220 and 230 can receive the beacon frame transmitted by the first electronic device 210. The beacon frame can include the group network identifier (such as a BSSID) configured by the first electronic device 210. If the password is input for joining the group network, each of the second and third electronic devices 220 and 230 can extract the group network identifier from the received beacon frame. The second and third electronic device 220 and 230 can execute the predefined hash function with the input of the password and the extracted identifier to generate the encryption key.

The second and third electronic devices 220 and 230 can join the group network created by the first electronic device 210 to communicate data encrypted with the encryption key shared among the electronic devices 210, 220, and 230 as denoted by reference number 205 and 207. For example, the first, second, and third electronic devices 210, 220, and 230 can transmit the data encrypted with the encryption key and decrypt the encrypted data received from another electronic device belonging to the group network based on the encryption key.

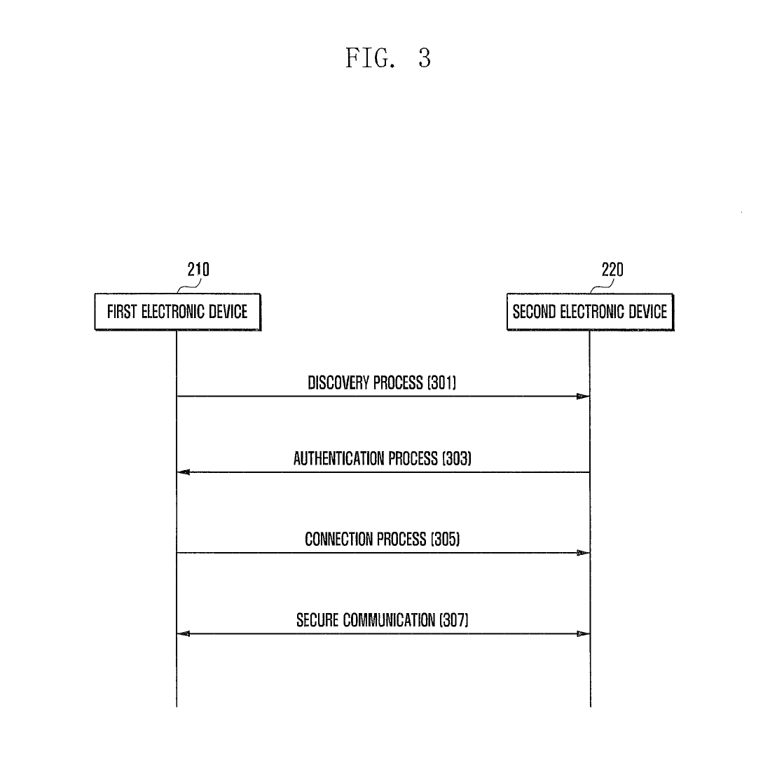

FIG. 3 is an example signal flow diagram illustrating signal flows between electronic devices for group communication according to this disclosure.

FIG. 3 is an example directed to an exemplary case of the secure connection setup between the first and second electronic devices 210 and 220.

Referring to FIG. 3, the first and second electronic devices 210 and 220 can perform discovery process at operation 301. For example, the first electronic device can broadcast a beacon frame including its group network identifier (such as a BSSID). At this time, the first electronic device 210 can execute a predefined hash function with the input of the password entered by the user and the temporary value corresponding to the group network identifier to generate and store an encryption key.

At operation 301, the second electronic device 220 can receive the beacon frame transmitted by the first electronic device 210, analyze the beacon frame, and extract the information and identifier of the first electronic device. The second electronic device 220 can receive the beacon frames transmitted by the neighbor electronic devices (such as the first electronic device 210) and select an appropriate electronic device (such as the first electronic device 210) based on the received beacon frame. The second electronic device 220 can execute the hash function with the input of the password entered by the user and the extracted identifier to generate and store the encryption key.

In an embodiment, the first and second electronic devices 210 and 220 can store the same hash function for generating the same encryption key.

The first and second electronic devices 210 and 220 can perform authentication process at operation 303. For example, the second electronic device 220 can perform the authentication process on the electronic device (such as the first electronic device 210) selected through the discovery process.

If the first electronic device is authenticated successfully, the second electronic device 220 can perform the connection setup process with the first electronic device 210 at operation 305. That is, the second electronic device 220 can join the group network created by the first electronic device 210.

The first and second electronic devices 210 and 220 can perform secure communication process using the encryption key at operation 307. For example, the first and second electronic devices 210 and 220 can communicate the data encrypted with the same encryption keys and decrypt the encrypted data received from the peer device using the same encryption key.

In an embodiment, the first and second electronic devices 210 and 220 can generate the same encryption key without complex message exchange so as to establish a connection immediately. If an electronic device has no predefined hash function and does not know the user password, this means that it may not be possible to generate a valid encryption key, to decrypt the data from other electronic devices of the group network, and to protect data against the electronic device that are not participated in the group.

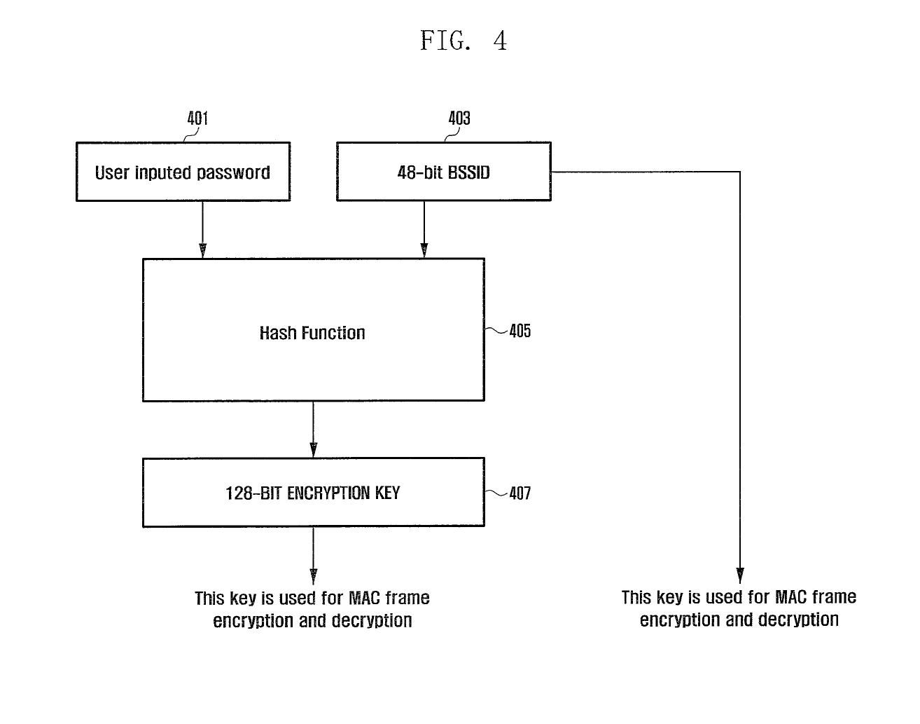

FIG. 4 is an example diagram illustrating a principle of the encryption key generation procedure of the electronic device according to this disclosure.

The secure connections among the electronic devices constituting the group network can be achieved with the password 401 input by the user, the group network identifier (such as 48-bit BSSID) 403, the predefined hash function 405, and the encryption key 407 generated by the hash function 405.

The electronic device 100 can execute the hash function 405 with the input of the password 401 and the identifier 403. The electronic device 100 can generate the security-reinforced encryption key (such as a 128-bit encryption key) using the hash function 405. The identifier can be included in the beacon frame broadcast periodically. The encryption key can be used for encrypting and decrypting MAC frames.

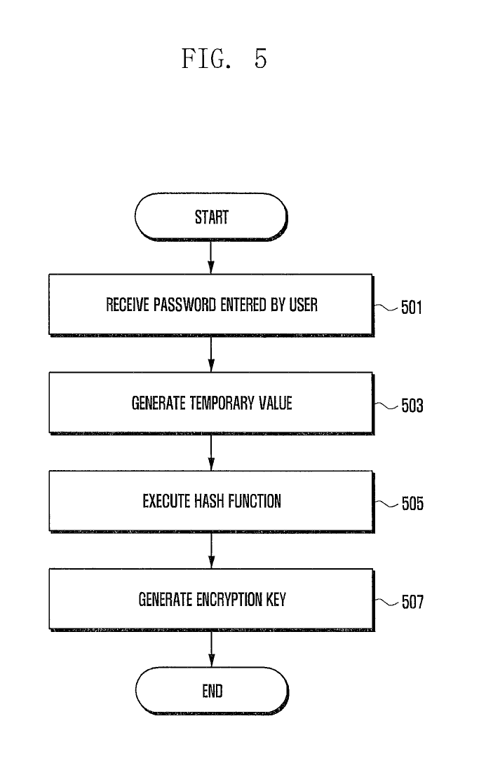

FIG. 5 is an example flowchart illustrating an encryption key generation procedure of an electronic device for forming a group network according to this disclosure. FIG. 5 is an example directed to an exemplary case where the electronic device creates a group network.

In FIG. 5, the electronic device 100 can be in the state of creating a group network according to the user manipulation or settings of the electronic device 100.

The control unit 180 can receive a password entered by the user at operation 501 and generate a temporary value for use of the 48-bit encryption algorithm based on the password entered by the user at operation 503. Here, the control unit 180 can generate a unique group network identifier (such as a BSSID) based on the temporary value and broadcast a beacon message including the group network identifier periodically.

The control unit 180 can execute the hash function predefined in the electronic device 100 with the input of the password entered by the user and the identifier (such as a 48-bit temporary value) at operation 505.

The control unit 180 can generate an encryption key (such as a 128-bit security-reinforced encryption key) for secure connection in the group network using the hash function at operation 507.

Afterward, the control unit 180 can control data communication encrypted with the encryption key within the group network to which the electronic device belongs. For example, the control unit 100 can transmit the data encrypted with the encryption key and decrypt the encrypted data received from other electronic devices in the group network.

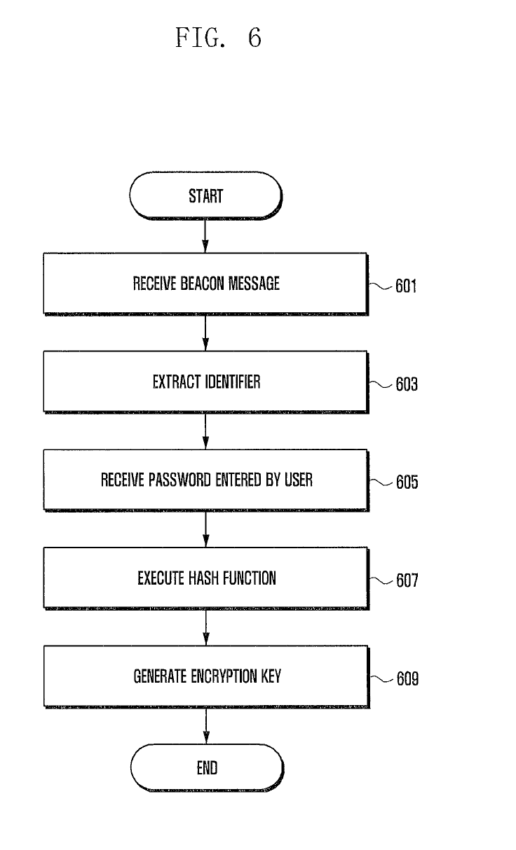

FIG. 6 is an example flowchart illustrating an encryption key generation procedure of an electronic device for group communication according to this disclosure. FIG. 6 is an example directed to an exemplary case where an electronic device joins the secure group network created already.

In FIG. 6, the electronic device within the range of the group network can attempt to join the group network according to the user manipulation or settings of the electronic device 100.

If a beacon frame transmitted by an adjacent electronic device is received at operation 601, the control unit 180 can extract an identifier from the beacon frame at operation 603.

If a password is input by the user at operation 605, the control unit can execute a hash function at operation 607. For example, the control unit 180 can execute the hash function predefined in the electronic device 100 with the input of the password entered by the user and the extracted identifier. In an embodiment, the execution order of operations 601 and 605 may not be limited to FIG. 6, but the user's password input of operation 605 can precede beacon frame reception operation 601.

The control unit 180 can generate an encryption key (such as a 128-bit security-reinforced encryption key) for secure connection in the group network using the hash function at operation 609.

Afterward, the control unit 180 can control communication of data encrypted with the encryption key in the group network to which the electronic device belongs. For example, the control unit 180 can transmit the data encrypted with the encryption key and decrypt the encrypted data received from other electronic devices of the group network using the encryption key.

As described above, the secure connection method and apparatus of the present disclosure can be advantageous in terms of minimizing user involvement and connection delay in the secure connection establishment procedures among a plurality of electronic devices. Unlike the conventional security connection method generating the encryption key through 4-way handshake in 1:1 which increases the connection delay in proportion to square of the number of electronic devices, the secure connection method and apparatus can generate the same encryption key without message exchange among the electronic devices, resulting in immediate connection establishment.

Also, the secure connection method and apparatus of the present disclosure can be advantageous in terms of preventing the data exchanged among the electronic devices forming a group network from being decrypted illegally (such as hacked) by the electronic device neither having a matched hash function or nor knowing the user password cannot generate a matching encryption key.

Furthermore, the secure connection method and apparatus can be advantageous in terms of protecting data from other electronic devices participating in the group abnormally.

The individual modules can be implemented by hardware, firmware, software, or a combination of them. Some or entire modules can be implemented as one entity responsible for the functions of the corresponding modules. The individual operations can be performed sequentially, repeatedly, or in parallel. Some operations can be omitted or performed along with other operations.

The above-described secure connection method can be implemented in the form of computer-executable program commands and stored in a computer-readable storage medium. The computer readable storage medium can store the program commands, data files, and data structures in individual or combined forms. The program commands recorded in the storage medium can be designed and implemented for various exemplary embodiments of the present disclosure or used by those skilled in the computer software field.

The computer-readable storage medium can include magnetic media such as a floppy disk and a magnetic tape, optical media including a Compact Disc (CD) ROM and a Digital Video Disc (DVD) ROM, a magneto-optical media such as a floptical disk, and the hardware device designed for storing and executing program commands such as ROM, RAM, and flash memory. The programs can command include the language code executable by computers using the interpreter as well as the machine language codes created by a compiler. The aforementioned hardware device can be implemented with one or more software modules for executing the operations of the various exemplary embodiments of the present disclosure.

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A data communication method of an electronic device, the method comprising:
generating an identifier of a group network based on a password entered by a user;
generating an encryption key based on the password and the identifier; and
communicating data using the encryption key in the group network.

2. The method of claim 1, wherein the generating of the encryption key comprises:
executing a hash function; and
generating the encryption key based on the password, the identifier, and the hash function.

3. The method of claim 2, wherein the generating of the encryption key comprises:
executing the hash function with the input of the password and the identifier; and
generating a 128-bit encryption key using the hash function.

4. The method of claim 2, wherein the generating of the identifier comprises:
generating a 48-bit temporary value based on the password; and
configuring the temporary value as the identifier of the group network.

5. The method of claim 4, wherein the identifier is a 48-bit Basic Service Set Identifier (BSSID).

6. The method of claim 2, wherein the identifier is included in a beacon frame broadcast periodically.

7. The method of claim 1, wherein the group network comprises a plurality electronic devices including a same hash function for use in generating the encryption key.

8. The method of claim 1, wherein the communicating of the data comprises:
transmitting data encrypted with the encryption key to another electronic device of the group network; and
decrypting the encrypted data received from the other electronic device using the encryption key.

9. A data communication method of an electronic device, the method comprising:
receiving a beacon frame broadcast by another electronic device in a group network;
extracting an identifier of the group network from the beacon frame;
generating an encryption key based on the identifier and a password entered by a user; and
performing data communication using the encryption key within the group network.

10. The method of claim 9, wherein the generating of the encryption key comprises:
executing a hash function; and
generating the encryption key using the password, the identifier, and the hash function.

11. The method of claim 10, wherein the generating of the encryption key comprises:
executing the hash function with input of the password and the identifier; and
generating a 128-bit encryption key using the hash function.

12. The method of claim 10, wherein the hash function is identical with the hash function stored in the electronic device.

13. The method of claim 12, wherein the generating of the encryption key comprises generating the encryption key so that the encryption key is identical to the encryption key generated by the electronic device.

14. The method of claim 9, wherein the performing of the data communication comprises:
transmitting data encrypted with the encryption key to another electronic device in the group network; and
decrypting encrypted data received from the other electronic device using the encryption key.

15. An electronic device comprising:
a storage unit configured to store a hash function for use in an encryption key and at least one program; and
a control unit which including at least one processor configured to execute the at least one program to control data communication of the electronic device in a group network,
wherein the at least one program comprises a program configured to generate the encryption key for use in data communication in the group network using a password entered by a user, an identifier of the group network, and the hash function.

16. The electronic device of claim 15, wherein the control unit is configured to generate the identifier of the group network based on the password entered by the user, execute the hash function with input of the password and the identifier, and generate a 128-bit encryption key using the hash function.

17. The electronic device of claim 15, wherein the control unit is configured to receive beacon frames transmitted by another electronic device of the group network, extract the identifier of the group network from the beacon frame, execute the hash function with input of the identifier and the password, and generate a 128-bit encryption key using the hash function.

18. The electronic device of claim 15, wherein the identifier is a 48-bit Basic Service Set Identifier (BSSID).

19. A data communication system comprising:
a first electronic device configured to generate an identifier of a group network based on a password entered by a user, generate an encryption key using the password, the identifier, and a predefined hash function, and communicate data encrypted with the encryption key with other electronic devices in the group network; and
a second electronic device configured to acquire the identifier from a frame broadcast by the first electronic device, generate an encryption key identical with the encryption key of the first electronic device using a password entered by a user, the identifier, and the hash function, and communicate data encrypted with the encryption key with the first electronic device.

20. The data communication system of claim 19, wherein the first and second electronic devices are configured to store the same hash function and generate the same encryption key using the hash function.

21. The data communication system of claim 19, wherein the identifier is a 48-bit Basic Service Set Identifier (BSSID), and the encryption key is a 128-bit encryption key corresponding to the hash function.

22. A computer-readable storage medium configured to store a program of instructions executable by a machine to perform a data communication method comprising:
receiving a password entered by a user;
generating an identifier of a group network;
executing a hash function with input of the password and the identifier; and
generating an encryption key for encrypting data communicated in the group network using the hash function.
